(19) United States
(12) Patent Application Publication
(10) Pub. No.: US 2015/0218394 A1
(43) Pub. Date: Aug. 6, 2015

(54) PRINTED MATTER AND METHOD FOR MANUFACTURING SUCH PRINTED MATTER

(71) Applicant: LG CHEM, LTD., Seoul (KR)

(72) Inventors: Dae Hyun Kim, Daejeon (KR); Seung Heon Lee, Daejeon (KR); Jooyeon Kim, Daejeon (KR); Mihee Park, Daejeon (KR); U Ra Lee, Daejeon (KR); Wonjoo Lee, Daejeon (KR); Hera Lee, Daejeon (KR)

(73) Assignee: LG CHEM, LTD., Seoul (KR)

(21) Appl. No.: 14/420,601

(22) PCT Filed: Aug. 2, 2013
(86) PCT No.: PCT/KR2013/006991

§ 371 Date: Feb. 9, 2015

(30) Foreign Application Priority Data
Aug. 7, 2012 (KR) 10-2012-0086176

(51) Int. Cl. C09D 11/02; C08G 63/127; C08G 63/13; C08G 75/23; C08G 64/00; C08F 116/06; C08F 110/02; C08F 110/06; C08F 122/40; B41F 7/02; C08G 69/26

(52) U.S. Cl. CPC C09D 11/02; B41F 7/02; C08G 63/127; C08G 63/13; C08G 75/23; C08G 69/26; C08F 116/06; C08F 110/02; C08F 110/06; C08F 122/40; C08G 64/00

(57) ABSTRACT

The present application relates to a method for manufacturing a printed matter, the method including: coating an ink layer on a substrate; and forming a printing pattern layer on the substrate by bringing a printing plate in contact with the ink layer to remove a portion other than a desired pattern from the ink layer. The manufacturing method of the present application is effective in reducing costs because the precision of the printing pattern is excellent and the manufacturing process is simple.

### TECHNICAL FIELD

The present application relates to a printed matter, a method for manufacturing the same, and a substrate used in a printing method. This application claims priority to and the benefit of Korean Patent Application No. 10-2012-0086176 filed in the Korean Intellectual Property Office on Aug. 7, 2012, the entire contents of which are incorporated herein by reference.

### BACKGROUND ART

In a display substrate, a photolithography method has been mainly used in order to form a pattern in the related art, but a process for forming a pattern is complicated, the manufacturing cost thereof is expensive, or there is a problem in the performance.

Thus, there is a need to develop a method which is simpler than the method for forming a pattern in the related art and may improve the performance thereof while reducing the costs thereof.

In general, electronic devices, such as liquid crystal display devices and semiconductor devices, are manufactured to have a pattern of numerous layers formed on a substrate. In order to form the pattern, a photolithography process has been mainly used so far. However, the photolithography process has a problem in that the manufacturing process is complicated and a large amount of chemical waste hazardous to the environment is generated because a predetermined pattern mask needs to be manufactured and a process of chemical etching and stripping needs to be repeated. This leads to an increase in manufacturing costs, thereby aggravating the competitiveness of a product. In order to solve the drawbacks of the photolithography process, methods of forming a fine pattern have been developed through a printing technique. When fine patterns are manufactured through a printing technique, there is an advantage in that the process is simple, the consumption of raw materials may be minimized, and the manufacturing costs are inexpensive due to no generation of waste liquid.

Meanwhile, examples of a printing technique, which enables the formation of fine patterns, include gravure printing, offset printing, screen printing and the like. Among them, offset printing is particularly useful because relatively fine printing patterns may be manufactured to have a uniform thickness.

In particular, the reverse offset printing process is a method for forming fine patterns by applying an ink on a blanket made of a polydimethylsiloxane (PDMS) rubber, removing an undesired pattern portion by a printing plate, and then transferring a pattern portion remaining on the blanket to a substrate.

A general method of the reverse offset printing process is illustrated in the following FIG. 1.

The reverse offset printing method is a technology that is receiving considerable attention in terms of saving costs and improving production speeds in forming patterns, but has a problem in that the blanket becomes swollen by a solvent contained in the ink when continuous printing is performed, and thus it is difficult to obtain a precise pattern.

Therefore, there is a need to develop other methods which may improve the disadvantage of the reverse offset printing process, for example, the precision of patterns deteriorates during continuous printing.

### CITATION LIST

### Patent Document

Korean Patent Application Laid-Open No. 10-2008-0090890

### DISCLOSURE

### Technical Problem

The present application has been made in an effort to provide a method for manufacturing a printed matter, in which costs may be reduced by improving the process efficiency or simplifying the process, and the precision of the printing pattern does not deteriorate even during continuous printing, and a printed matter manufactured thereby.

### Technical Solution

An exemplary embodiment of the present application provides a method for manufacturing a printed matter, the method including: coating an ink layer on a substrate; and forming a printing pattern layer on the substrate by bringing a printing plate in contact with the ink layer to remove a portion other than a desired pattern from the ink layer.

An exemplary embodiment of the present application provides a substrate having a surface energy from 22 mN/m to 50 mN/m and a visible light transmittance of 80% or more, which is used in the manufacturing method.

An exemplary embodiment of the present application provides a substrate of which at least one surface is surface-treated, the surface-treated surface of the substrate having a surface energy from 20 mN/m to 40 mN/m and a visible light transmittance of 80% or more, which is used in the manufacturing method.

An exemplary embodiment of the present application provides an ink composition for roll printing having a surface energy from 18 mN/m to 30 mN/m when coated on a substrate, which is used in the manufacturing method.

An exemplary embodiment of the present application provides a printed matter manufactured by the manufacturing method.

An exemplary embodiment of the present application provides a printed matter including: a substrate; and a printing pattern layer provided on one surface of the substrate.

An exemplary embodiment of the present application provides a display substrate including the printed matter.

An exemplary embodiment of the present application provides an electronic device including the display substrate.

### Advantageous Effects

The printed matter according to an exemplary embodiment of the present application implements a precise printing pattern, and the method for manufacturing the printed matter has a significant cost reduction effect due to simplified processes.

### DESCRIPTION OF DRAWINGS

FIG. 1 illustrates a reverse offset printing method.

FIG. 2 illustrates a method for manufacturing a printed matter according to an exemplary embodiment of the present application.

### MODE FOR INVENTION

The advantages and features of the present application, and methods of accomplishing the advantages and features will become obvious with reference to exemplary embodiments to be described below in detail along with the accompanying drawings. However, the present application is not limited to the exemplary embodiments to be disclosed below, but will be implemented in various forms different from each other. The exemplary embodiments are merely intended to make the disclosure of the present application complete and to completely notify the person with ordinary skill to which the present application pertains of the scope of the invention, and the present application is only defined by the scope of claims. The size and relative size of the constituent elements marked in the drawings may be exaggerated for clarity of description.

Unless otherwise defined, all terms including technical and scientific terms used in the present specification may be used as the meaning which may be commonly understood by the person with ordinary skill in the art to which the present application pertains. Terms defined in commonly used dictionaries should not be interpreted in an idealized or excessive sense unless clearly and particularly defined.

Hereinafter, the present application will be described in detail.

An exemplary embodiment of the present application provides a method for manufacturing a printed matter, the method including: coating an ink layer on a substrate; and forming a printing pattern layer on the substrate by bringing a printing plate in contact with the ink layer to remove a portion other than a desired pattern from the ink layer.

An exemplary embodiment of the present application provides a printing method, including: coating an ink layer on a substrate; and forming a printing pattern layer on the substrate by bringing a printing plate in contact with the ink layer to remove a portion other than a desired pattern from the ink layer.

The method according to an exemplary embodiment of the present application may further include surface-treating a surface of the substrate which is in contact with the ink layer before the coating of the ink layer on the substrate.

The substrate may have a surface energy from 22 mN/m to 50 mN/m. When the method further includes surface-treating the surface of the substrate which is in contact with the ink layer, the surface-treated substrate may have a surface energy from 20 mN/M to 40 mN/m.

Specifically, the substrate may be surface-treated such that the surface energy of the substrate may be controlled so as to be suitable for forming the printing pattern layer. Alternatively, as an example of the surface treatment of the substrate, a coating layer may be provided on a surface of the substrate which is in contact with the printing pattern layer. In an exemplary embodiment of the present application, release characteristics of the coating layer may be controlled by controlling a concentration or a composition of a material having release characteristics. Further, the coating layer may contain a reactive group in constituting the release component, and thus it is possible to control adhesion characteristics by reacting the reactive group with the substrate or with the reactive group contained in the printing pattern layer by UV curing or heat treatment in forming the printing pattern layer by controlling the concentration and composition of the reactive group, and drying the printing pattern layer. The material having release characteristics may be formed specifically by a composition including a silicone-based release material or a fluorine-based release material. For example, as a release material, it is possible to use a silicone-based release material selected from the group consisting of polyorgano siloxane, polyhydrogen siloxane, and derivatives thereof, and it is possible to use a fluorine-based release material selected from the group consisting of a tetrafluoroethylene resin, a perfluoroalkyl group-containing ester compound, and derivatives thereof. These materials may also be used while the concentration, composition and the like of these materials are controlled.

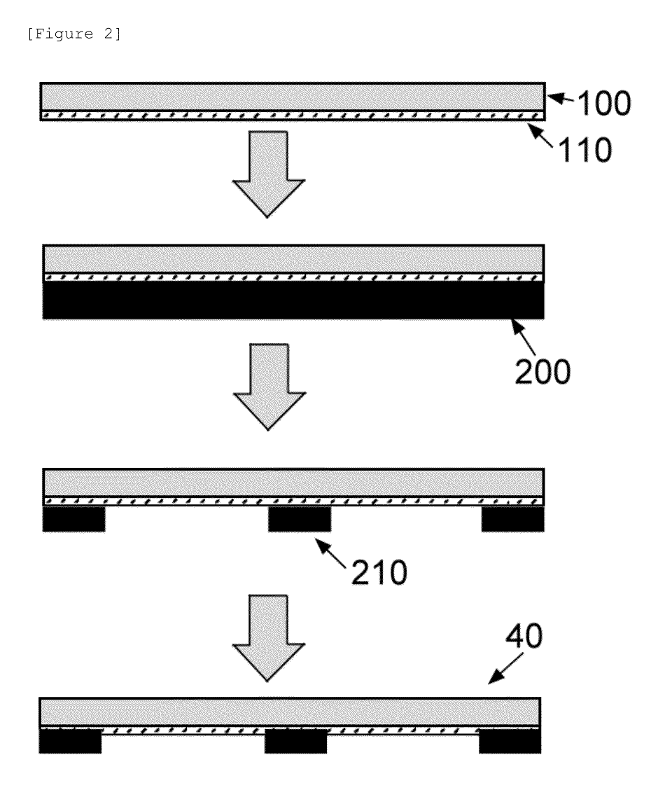

When the printing pattern layer is formed by the method illustrated in FIG. 2, and then UV is irradiated or heat is applied thereto, the coating layer may increase the adhesion strength of the substrate or the printing pattern layer. When the adhesion strength of the coating layer is increased, the adhesion strength of the substrate and the printing pattern layer is increased, thereby leading to an effect that the printing pattern layer does not easily detach. The coating layer may include a reactive group of which the adhesion strength is increased specifically when UV is irradiated or heat is applied thereto. The reactive group may be selected from the group consisting of a hydroxyl group, a carboxyl group, an amine group, a sulfonic acid group, an epoxy group, and an ethylenically unsaturated group, but is not limited thereto.

When UV is irradiated or heat is applied to the coating layer, the adhesion strength of the substrate and the printing pattern layer may be increased.

The coating layer may have a thickness from 1 nm to 10 μm. When the thickness thereof is 1 nm or more, it is possible to prevent a problem in that the thickness of the coating layer is too small to properly serve as a coating layer between the printing pattern layer and the substrate. When the thickness is 10 μm or less, it is possible to prevent a problem in that the coating layer is so thick that the transmittance of the substrate on which the printing pattern is formed may be decreased or the adhesion strength with the substrate may be weakened.

In the coating of the ink layer on the substrate in the method according to an exemplary embodiment of the present application, the used ink may have a surface energy from 18 mN/m to 30 mN/m. Since the ink composition that coats the ink layer includes a large amount of solvent and has an organic solvent as a main component, the ink composition may have a surface energy from 18 mN/m to 30 mN/m due to characteristics such as the surface tension of the solvent itself, the component of the solvent, other constituent components of the ink composition, and compatibility with a surfactant.

In the coating of the ink layer on the substrate, the surface energy of the ink needs to be lower than the surface energy of the substrate in order to form a good coating layer without causing any coating defects. In general, the higher the surface energy difference between the ink and the substrate is, the better the wetting characteristics of the ink is, thereby forming a good coating layer.

In the method according to an exemplary embodiment of the present application, the printing plate may include a desired pattern as an engraved portion, and a portion other than the desired pattern as an embossed portion. The printing plate may be in a roll or flat plate form.

In the forming of the printing pattern layer in the method according to an exemplary embodiment of the present application, the printing pattern layer may be formed by bringing the embossed portion of the printing plate in contact with the ink layer to remove a portion other than the desired pattern from the ink layer.

The printing pattern layer may have a line height (height) from 0.1 μm to 10 μm, specifically, from 0.5 μm to 5 μm.

The pattern of the printing pattern layer may be a pattern that may be used in a display substrate, specifically, one or two or more patterns selected from the group consisting of a color filter, a black matrix, a column spacer, a gate line, a data line, a gate electrode, a source electrode, a drain electrode, a bezel pattern of a touch panel, a bridge pattern of a touch sensor, and an electrode pattern of a touch sensor.

In the method according to an exemplary embodiment of the present application, it is preferred that the embossed portion has surface energy of 50 mN/m or more. In order to remove an undesired pattern portion in the ink layer from the substrate by bringing the ink layer applied on the substrate with the embossed portion of the printing plate, it is preferred that the surface energy of the embossed portion of the printing plate is higher than the surface energy of the substrate.

The method according to an exemplary embodiment of the present application may further include drying the printing pattern layer after the forming of the printing pattern layer.

The drying of the printing pattern layer may be performed by irradiating UV or performing sintering.

The effect is good when the sintering temperature is 190° C. or less, more specifically, 150° C. or less. When UV is irradiated or sintering is performed in the drying of the printing pattern layer, it is possible to improve the adhesion strength between the substrate and the printing pattern layer.

After the drying of the printing pattern layer in the method according to an exemplary embodiment of the present application, the printing pattern layer which is finally formed may have a surface energy from 20 mN/m to 50 mN/m. It is because most of the solvent components in the drying of the printing pattern layer are removed, and as a result, the surface energy of the printing pattern layer may be increased up to 2 mN/m to 20 mN/m. In this case, there is little difference in the surface energy between the substrate and the printing pattern layer.

Before the drying of the printing pattern layer, the difference between the surface energy of the substrate and the surface energy of the printing pattern layer may be more than 0 mN/m and 20 mN/m or less at the interface between the substrate and the printing pattern layer.

In the manufacturing method or printing method of a printed matter according to an exemplary embodiment of the present application, applying ink on a blanket is omitted, and transferring a pattern portion remaining on the blanket to a substrate is also omitted, when compared to a reverse offset printing method. Moreover, the manufacturing method or printing method of a printed matter according to an exemplary embodiment of the present application includes only removing an undesired pattern portion by a printing plate, which is an off-process in the reverse offset printing method, and thus there is an advantage in that the manufacturing process is further simplified. Further, since the present application does not use a blanket, there is no problem in that the precision of the pattern and the precision of the alignment are significantly reduced due to the swelling and deswelling of the blanket during continuous printing according to the reverse offset printing method. Therefore, the manufacturing method or printing method of a printed matter according to an exemplary embodiment of the present application has an effect of reducing costs due to a simple process, and is advantageous in that the precision of the pattern of a printed matter manufactured is not reduced even during continuous printing.

An exemplary embodiment of the present application provides a printed matter manufactured by the manufacturing method or printing method of a printed matter.

In the printed matter manufactured by the manufacturing method or printing method of a printed matter, the difference between the surface energy of the substrate and the surface energy of the printing pattern layer may be more than 0 mN/m and 20 mN/m or less at the interface between the substrate and the printing pattern layer before curing or drying.

An exemplary embodiment of the present application provides a substrate having a surface energy from 22 mN/m to 50 mN/m and a visible light transmittance of 80% or more, which is used in the manufacturing method or printing method of a printed matter.

An exemplary embodiment of the present application provides a substrate of which at least one surface is surface-treated, the surface-treated surface of the substrate having a surface energy from 20 mN/m to 40 mN/m and a visible light transmittance of 80% or more, which is used in the manufacturing method or printing method of a printed matter. The description on the surface treatment of the substrate is the same as described above.

The substrate used in the method may be a plastic film. Specifically, the plastic may be a mixed resin of one or two or more selected from the group consisting of polyethyleneterephthalate (PET), polybutyleneterephthalate (PBT), polyethylenenaphthalate (PEN), polybutylenenaphthalate (PBN), polyacrylonitirile (PAN), polymethylmethacrylate (PMMA), polyvinylalcolol (PVA), polyamide (PA), polyimide (PI), polycarbonate (PC), polyether sulfone (PES), polyamide (PA), polyvinylalcolol (PVA), nylon, polyethylene (PE), and polypropylene (PP).

An exemplary embodiment of the present application provides an ink composition for roll printing having a surface energy from 18 mN/m to 30 mN/m when coated on a substrate, which is used in the manufacturing method or printing method of a printed matter.

An exemplary embodiment of the present application provides a printed matter including: a substrate; and a printing pattern layer provided on one surface of the substrate.

Before curing or drying the printed matter, the difference between the surface energy of the substrate and the surface energy of the printing pattern layer may be more than 0 mN/m and 20 mN/m or less at the interface between the substrate and the printing pattern layer.

In an exemplary embodiment of the present application, the substrate may be a substrate in which one surface in contact with the printing pattern layer is surface-treated. The description on the surface treatment of the substrate is the same as described above. The substrate may be a substrate including a coating layer on a surface in contact with the printing pattern layer. The description on the coating layer is the same as described above.

The substrate may be a plastic film, and the specific description thereof is the same as described above.

In the printed matter according to an exemplary embodiment of the present application, the printing pattern layer may have a line height (height) from 0.1 μm to 10 μm, specifically, from 0.5 μm to 5 μm.

The pattern of the printing pattern layer may be a pattern that may be used in a display substrate, specifically, one or two or more patterns selected from the group consisting of a color filter, a black matrix, a column spacer, a gate line, a data line, a gate electrode, a source electrode, a drain electrode, a bezel pattern of a touch panel, a bridge pattern of a touch sensor, and an electrode pattern of a touch sensor.

An exemplary embodiment of the present application provides a display substrate including the printed matter.

Examples of the display substrate according to an exemplary embodiment of the present application include a plasma display panel (PDP), a liquid crystal display (LCD) panel, an electrophoretic display panel, a cathode-ray tube (CRT) panel, an OLED display panel, or a touch panel, and the like.

An exemplary embodiment of the present application provides an electronic device including the display substrate.

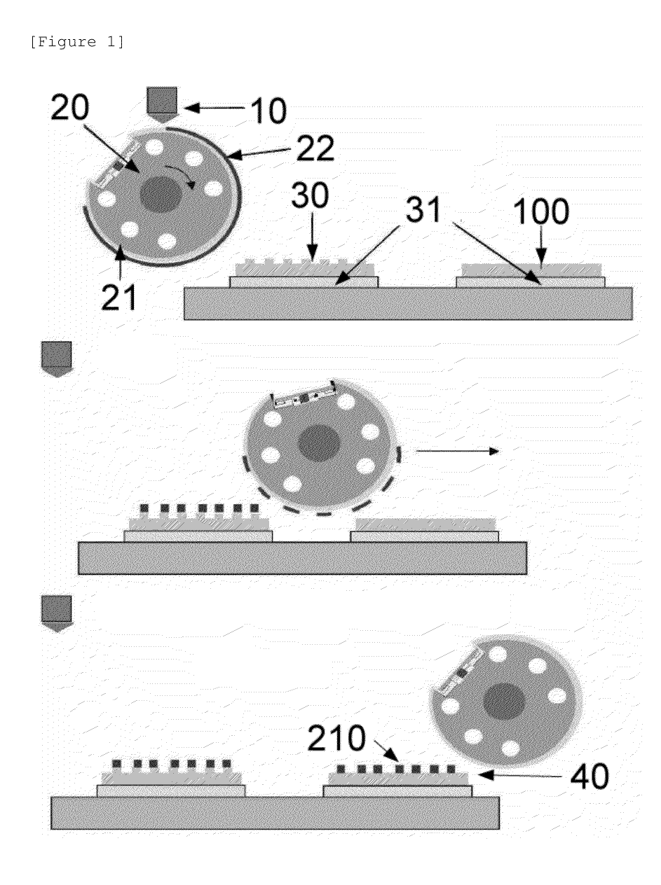

FIG. 1 illustrates a reverse offset printing method. In FIG. 1, reference numeral 10 is a coater which coats a metal pattern material on the blanket, reference numeral 20 is a printing roll for supporting a blanket, reference numeral 21 is a blanket, and reference numeral 22 is an ink composition applied on a blanket. Reference numeral 30 is a printing plate having a pattern, and a pattern corresponding to a pattern to be formed is formed as an engraved portion. Reference numeral 31 is a stage that supports a printing plate and a substrate, reference numeral 40 is a printed matter, and reference numeral 210 is a printing pattern transferred on the printed matter.

FIG. 2 illustrates a method for manufacturing a printed matter according to an exemplary embodiment of the present application. In FIG. 2, reference numeral 100 is a substrate, reference numeral 110 indicates a surface-treating layer, reference numeral 200 is an ink layer applied on a surface-treated substrate, reference numeral 210 indicates a printing pattern layer in which a pattern is formed by removing a portion other than a desired pattern from the ink layer by being brought in contact with a printing plate, and reference numeral 40 indicates a printed matter manufactured through a sintering process.

### EXPLANATION OF REFERENCE NUMERALS AND SYMBOLS

10: Coater
20: Printing roll
21: Blanket
22: Ink composition
30: Printing plate
31: Stage
40: Printed matter
100: Substrate
110: Surface-treating layer
200: Ink layer
210: Printing pattern layer

1. A method for manufacturing a printed matter, the method comprising:
coating an ink layer on a substrate; and
forming a printing pattern layer on the substrate by bringing a printing plate in contact with the ink layer to remove a portion other than a desired pattern from the ink layer.

2. The method of claim 1, further comprising:
surface-treating a surface of the substrate, which is in contact with the ink layer, before the coating of the ink layer on the substrate.

3. The method of claim 2, wherein the substrate has a surface energy from 20 mN/m to 40 mN/m at an interface between the substrate and the ink layer.

4. The method of claim 2, wherein the surface-treating of the surface of the substrate forms a coating layer on a surface of the substrate which is in contact with the ink layer.

5. The method of claim 4, wherein the coating layer is formed of a composition comprising a silicone-based release material or a fluorine-based release material.

6. The method of claim 4, wherein the coating layer is formed by a composition comprising a material selected from the group consisting of polyorgano siloxane or derivatives thereof, polyhydrogen siloxane or derivatives thereof, a tetrafluoroethylene resin, and a perfluoroalkyl group-containing ester compound and derivatives thereof.

7. The method of claim 4, wherein the coating layer is formed so as to increase an adhesion strength when UV is irradiated or heat is applied thereto.

8. The method of claim 4, wherein the coating layer is formed so as to comprise a reactive group selected from the group consisting of a hydroxyl group, a carboxyl group, an amine group, an amine group, a sulfonic acid group, an epoxy group, and an ethylenically unsaturated group.

9. The method of claim 4, wherein the coating layer has a thickness from 1 nm to 10 μm.

10. The method of claim 1, wherein the ink used in the coating of the ink layer on the substrate has a surface energy from 18 mN/m to 30 mN/m, and the surface energy of the ink is lower than the surface energy of the substrate.

11. The method of claim 1, wherein in the forming of the printing pattern layer, the printing plate comprises a desired pattern as an engraved portion, and a portion other than a desired pattern as an embossed portion, and the printing pattern layer is formed by bringing the embossed portion of the printing plate in contact with the ink layer to remove a portion other than a desired pattern from the ink layer.

12. The method of claim 11, wherein the embossed portion has a surface energy of 50 mN/m or more, and the surface energy of the embossed portion is higher than the surface energy of the substrate.

13. The method of claim 11, wherein the printing plate is in a roll or flat plate form.

14. The method of claim 1, further comprising:
drying the printing pattern layer after the forming of the printing pattern layer.

15. The method of claim 14, wherein the drying of the printing pattern layer is performed by irradiating UV thereto or performing sintering at a temperature of 190° C. or less.

16. The method of claim 14, wherein a difference between the surface energy of the substrate and the surface energy of the printing pattern layer is more than 0 mN/m and 20 mN/m or less at an interface between the substrate and the printing pattern layer before the drying of the printing pattern layer.

17. A substrate having a surface energy from 22 mN/m to 50 mN/m and a visible light transmittance of 80% or more, which is used in the manufacturing method of claim 1.

18. A substrate of which at least one surface is surface-treated, the surface-treated surface of the substrate having a surface energy from 20 mN/m to 40 mN/m and a visible light transmittance of 80% or more, which is used in the manufacturing method of claim 1.

19. An ink composition for roll printing having a surface energy from 18 mN/m to 30 mN/m when coated on a substrate, which is used in the manufacturing method of claim 1.

20. A printed matter manufactured by the manufacturing method of claim 1.

21. A printed matter comprising:
a substrate; and
a printing pattern layer provided on one surface of the substrate.

22. The printed matter of claim 21, wherein before curing the printed matter, a difference between the surface energy of the substrate and the surface energy of the printing pattern layer is more than 0 mN/m and 20 mN/m or less at an interface between the substrate and the printing pattern layer.

23. The printed matter of claim 21, wherein a surface of the substrate in contact with the printing pattern layer is surface-treated.

24. The printed matter of claim 23, wherein the substrate comprises a coating layer on a surface in contact with the printing pattern layer.

25. The printed matter of claim 24, wherein the coating layer is formed by a composition comprising a silicone-based release material or a fluorine-based release material.

26. The printed matter of claim 24, wherein the coating layer has a thickness from 1 nm to 10 μm.

27. The printed matter of claim 21, wherein the substrate is a plastic film.

28. The printed matter of claim 27, wherein the plastic is a mixed resin of one or two or more selected from the group consisting of polyethyleneterephthalate (PET), polybutyleneterephthalate (PBT), polyethylenenaphthalate (PEN), polybutylenenaphthalate (PBN), polyacrylonitirile (PAN), polymethylmethacrylate (PMMA), polyvinylalcolol (PVA), polycarbonate (PC), polyether sulfone (PES), polyamide (PA), polyimide (PI), polyamide (PA), polyvinylalcolol (PVA), nylon, polyethylene (PE), and polypropylene (PP).

29. The printed matter of claim 21, wherein a pattern of the printing pattern layer is one or two or more patterns selected from the group consisting of a color filter, a black matrix, a column spacer, a gate line, a data line, a gate electrode, a source electrode, a drain electrode, a bezel pattern of a touch panel, a bridge pattern of a touch sensor, and an electrode pattern of a touch sensor.

30. A display substrate comprising the printed matter of claim 21.

31. The display substrate of claim 30, wherein the display substrate is a plasma display panel (PDP), a liquid crystal display (LCD) panel, an electrophoretic display panel, a cathode-ray tube (CRT) panel, an OLED display panel, or a touch panel.

32. An electronic device comprising the display substrate of claim 30.
